(19) United States
(12) Patent Application Publication
(10) Pub. No.: US 2016/0280471 A1
(43) Pub. Date: Sep. 29, 2016

(54) HEAT-RESISTANT SUCTION DEVICE

(71) Applicant: SCHWARTZ GMBH, SIMMERATH (DE)

(72) Inventor: ROLF-JOSEF SCHWARTZ, SIMMERATH (DE)

(73) Assignee: SCHWARTZ GMBH, SIMMERATH (DE)

(21) Appl. No.: 14/898,863

(22) PCT Filed: Jun. 12, 2014
(86) PCT No.: PCT/EP2014/062176

§ 371 Date: May 10, 2016

(30) Foreign Application Priority Data
Jun. 18, 2013 (DE) 10 2013 211 417.6

(51) Int. Cl. B65G 47/91; B66C 1/02; B25J 15/06

(52) U.S. Cl. CPC B65G 47/91; B25J 15/0616; B66C 1/0243

(57) ABSTRACT

The invention relates to a heat-proof suction device for hot metal sheets. A suction device according to the invention for picking up and holding an essentially flat metal object has a suction gripper having a suction chamber and having a jacket that laterally encloses the suction chamber and that is elastically deformable in the vertical direction essentially perpendicular to the surface of the object that is to be picked up. In this context, the jacket that is elastically deformable in the vertical direction consists of a metal that is heat-resistant up to at least 1000° C.

The invention relates to a heat-proof suction device for hot metal sheets.

When metal sheets undergo heat treatment, they are normally first heated in a furnace and subsequently exposed to a specific atmosphere and/or cooled off in another device. In the specific atmosphere, the surface of the metal sheets can be changed so that specific surface properties can be achieved. When the hot metal sheets are cooled off, the crystal structure can be changed so that it is possible to change the properties in terms of their hardness and ductility. For example, a press-hardening process is known in which metal sheets are heated in a furnace and subsequently deformed in a cooled pressing tool, whereby at the same time, the metal structure changes so that the metal sheets are hardened.

The various process steps are normally carried out in different devices. This means that the blanks heated in the furnace have to be transported to a subsequent device while they are hot. In this context, for example, steel blanks for the press-hardening process can be at temperatures of approximately 1000° C. Adapted mechanical grippers with a compressed-air drive are normally used to transport such hot steel blanks. Since these grippers are usually adapted to the geometry of the blanks, they have to be replaced when the product is changed. Furthermore, the grippers are often used to reposition the blanks that have become incorrectly oriented during the heating process and/or that have expanded due to the heat. Moreover, in the case of very thin blanks, clamp grippers are used in order to protect the thermally softened sheet metal from sagging. The high accelerations that occur in all directions during the transport under production conditions are definitely transmitted to the blanks by the grippers.

French patent application FR 2924373 describes a component-neutral lifting system. Several suction cups are arranged in a grid on a baseplate. The suction cups are made of an elastic material and have a deformable jacket, whereby this jacket encloses a cavity to which a vacuum can be applied. The baseplate can be positioned in such a way on the object that is to be lifted that the suction cups are in contact with the surface of this object. Irregularities in the surface of the object that is to be lifted are compensated for by the elasticity of the suction cups. Thanks to the elastic material of the suction cups, they are even sealed vis-à-vis the surface of the object that is to be lifted and this occurs to such an extent that, when a negative pressure is applied to the cavities of the suction cups, this negative pressure is retained and the object that is to be lifted is gripped by the suction cups. Such suction cups normally consist of cross-linked or thermoplastic elastomers that normally can only be used up to temperatures of approximately 200° C.

The J. Schmalz GmbH company, Aacher Straβe 29, 72293 Glatten, Germany, offers suction grippers for high-temperature applications on the Internet at http://de.schmalz.com/np/pg/produkte?hier=155-171-198. These suction grippers have a body made of stainless steel and a gasket made of a special woven fabric, and these suction grippers are heat-resistant up to a temperature of 600° C. Consequently, these grippers likewise cannot be used to handle metal blanks in a press-hardening process.

The objective of the invention is to put forward a suction device for use with metal blanks that are at a temperature of approximately 1000° C.

According to the invention, this objective is achieved by a suction device having the features of the independent claim 1. Advantageous refinements of the suction device can be gleaned from the subordinate claims 2 to 7.

Another objective of the invention is to put forward a component-neutral vacuum lifting system having a suction device according to the invention, to be used for sheet metal blanks that are at a temperature of approximately 1000° C.

This objective is achieved by a vacuum lifting system having the features of the alternative independent claim 8. Advantageous refinements of the vacuum lifting system can be gleaned from the subordinate claims 9 to 11.

A suction device according to the invention for picking up and holding an essentially flat metal object has a suction gripper with a suction chamber and with a jacket that laterally encloses the suction chamber and that is elastically deformable in the vertical direction essentially perpendicular to the surface of the object that is to be picked up.

In this context, the jacket that is elastically deformable in the vertical direction consists of a metal that is heat-resistant up to at least 1000° C. In this context, the term “heat-resistant” refers to a state that still has a minimum dimensional stability and minimum mechanical properties. Due to the jacket that is elastically deformable in the vertical direction, the cross sectional surface of the jacket facing the object that is to be picked up can adapt to the surface of the object that is to be picked up to such an extent that, when a negative pressure is applied to the suction chamber surrounded by the jacket, any leakage that might occur between the jacket and the object that is to be lifted remains so negligible that the negative pressure that can be generated by a vacuum pump is sufficient to grip the object by means of suction and to lift it. Depending on the size and weight of the object that is to be lifted, several suction devices according to the invention can be combined with each other. By suitably selecting the material for the jacket, hot metal sheets of various temperatures can be picked up.

In a preferred embodiment, the jacket that is elastically deformable in the vertical direction can consist of a metal with a low thermal conductivity, especially with a thermal conductivity of less than 20 W/mK. As a result, the heat dissipation from the metal object that is to be lifted caused by contact with the suction grippers remains within acceptable limits so that the temperature of the blanks especially does not fall below a minimum temperature needed for the hardening process. In a particularly preferred embodiment, the jacket that is elastically deformable in the vertical direction has a thermal conductivity of approximately 15 W/mK. Such a thermal conductivity is achieved, for instance, by the austenitic, high-alloyed steel grades X5CrNi18-10 (material number 1.4301), X15CrNiSi20-12 (material number 1.4828) or GX40CrNiSi25-20 (material number 1.4848).

The heat dissipation from the hot metal object that is to be picked up is further reduced if the jacket has a thin-walled design, at least in the area that comes into contact with the metal object when it is being picked up. Moreover, the jacket can also have a thin-walled design in its entirety. In actual practice, a wall thickness—at least in the contact area—of at most 0.1 mm to 0.5 mm has proven to be suitable when steel grades 1.4828 or 1.4848 are used.

In another preferred embodiment, the jacket that is elastically deformable in the vertical direction has a bellows-like contour. The vertical elastic deformability is improved by this contour shape and relatively large degrees of deformation are possible. This is especially advantageous if the metal object that is to be picked up is three-dimensionally curved and if it is picked up with several suction grippers that are arranged in one plane on a vacuum lifting system. Due to the conceivable large deformation paths, it is possible to compensate for the different distances between the surfaces of the curved object that is to be gripped by means of suction and the plane on which the suction grippers are arranged. Moreover, in view of the large material portion in the circumferential direction of the jacket, there is a great resistance against a collapse of the jacket when a negative pressure is applied, so that a suction chamber enclosed by the jacket in the circumferential direction is retained, even when strong negative pressures are applied.

Here, the term “vacuum” refers not only to an absolute vacuum, but also to any air pressure that is less than normal atmospheric pressure at the operating site of the suction device or of the vacuum lifting system.

In an alternative embodiment, the jacket that is elastically deformable in the vertical direction has a disc-shaped contour. Such a contour is advantageous if the deformation paths that the jacket has to traverse are not very large, that is to say, in case of less three-dimensionally curved objects that are to be picked up, especially with the parallel use of several suction grippers arranged on a vacuum lifting system in one plane. The flat disc shape has the advantage over the bellows shape that the installation height of the suction gripper is smaller and thus the wear and susceptibility to malfunction are minimized. Furthermore, with this design, a collapse of the jacket is virtually ruled out, even when very strong negative pressures are applied.

A component-neutral vacuum lifting system according to the invention is characterized in that the vacuum lifting system has a suction device according to one of the preceding claims.

In a preferred embodiment, the component-neutral vacuum lifting system has a plurality of suction devices according to the invention, whereby the vacuum lifting system has a baseplate with an underside, and the suction grippers are arranged in a grid on the underside of the baseplate. In the case of several suction grippers that are arranged in the grid, that are used in parallel and that grip the same object by means of suction at different places, the load is distributed essentially uniformly among the suction grippers. As a result, the capacity of the individual suction grippers can be less. The applied vacuum can likewise be less. If the metal object that is to be picked up is a thin metal blank that is heated to approximately 1000° C., it could happen that the blank might sag in only one place and become warped. Moreover, if an extreme vacuum is applied, the blank could bend at the place opposite from the suction chamber in the direction of the suction chamber. These risks are prevented by an arrangement of several suction grippers in a grid.

Moreover, it has proven to be advantageous if individual suction grippers can be activated and deactivated. For example, if a blank is to be lifted whose surface dimensions are smaller that that of the vacuum lifting system, then it can happen that not all of the suction grippers are still in contact with the blank. Due to this suction gripper or these suction grippers, the negative pressure would be equalized by the atmosphere, and the lifting procedure would only be possible in case of very lightweight blanks or it might not be possible at all. Furthermore, an extreme suction volume of the vacuum pump would be needed in order to maintain sufficient negative pressure for the lifting procedure. Thanks to the arrangement according to the invention, the energy consumption is reduced to the bare minimum.

Each suction gripper can be supplied by its own vacuum pump. The vacuum pump in question can be activated or deactivated for purposes of individual activation or deactivation. However, it has proven to be advantageous for the suction grippers of a vacuum lifting system to each be connected to a central suction line via a valve, whereby each valve can be individually placed in an open or closed position. This can be effectuated, for example, by means of solenoid valves. With this arrangement, the vacuum lifting system can be operated with just one vacuum pump. The latter can be installed in a decentralized place and can also supply other vacuum lifting systems with negative pressure. All that needs to be done is to connect a central vacuum line to the mobile vacuum lifting system, and this optimizes the installation work and the mobility of the system.

Consequently, the component-neutral vacuum lifting system according to the invention makes it possible to pick up different objects without having to retool the system for this purpose. It is sufficient to activate or deactivate individual suction grippers on an as-needed basis by opening or closing the appropriate valve.

Additional advantages, special features and practical refinements of the invention can be gleaned from the subordinate claims and from the presentation below of preferred embodiments making reference to the figures.

The figures show the following:

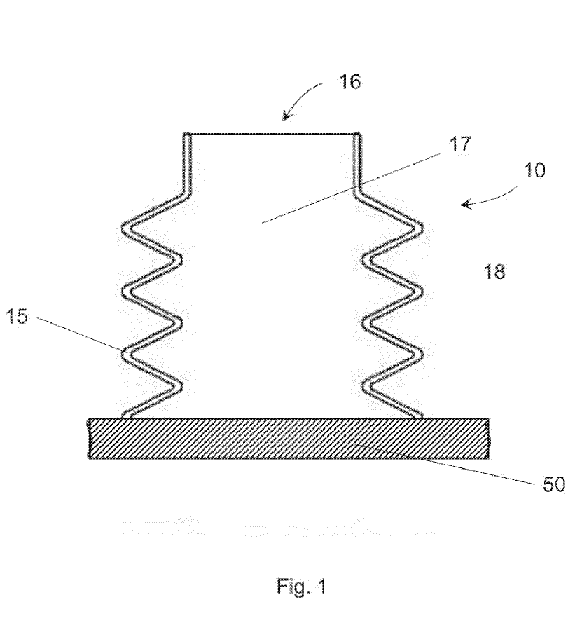

FIG. 1 a suction gripper according to the invention, in a sectional view,

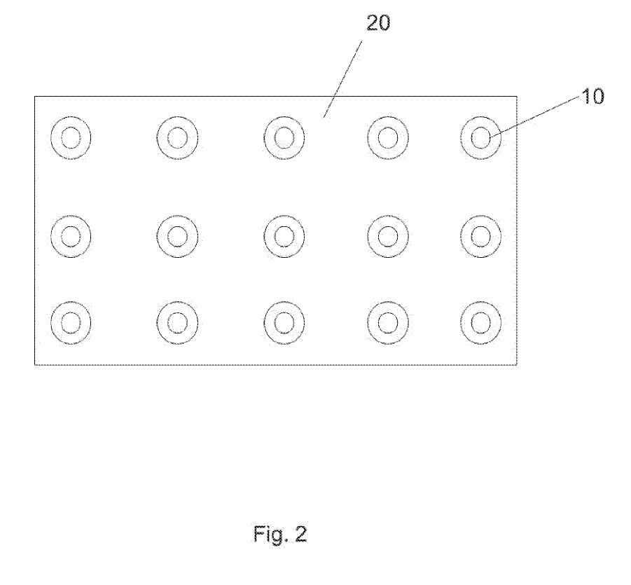

FIG. 2 the top view of the underside of a baseplate of a component-neutral vacuum lifting system according to the invention,

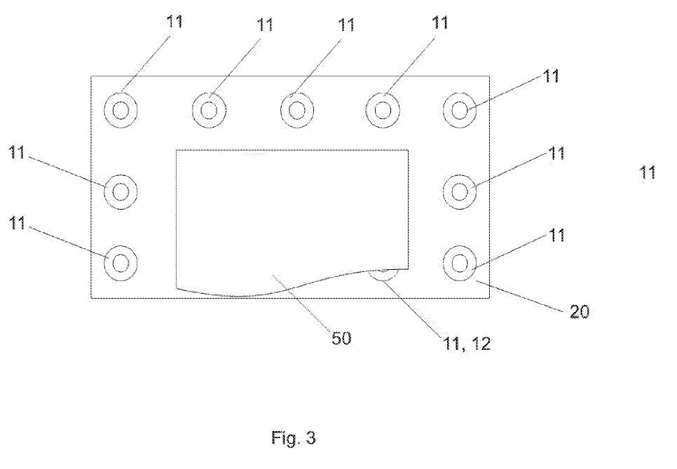

FIG. 3 the top view of the underside of a baseplate of a component-neutral vacuum lifting system according to the invention, showing a metal blank that has been picked up.

FIG. 1 shows a suction gripper 10 according to the invention, in a sectional view. The suction gripper 10 has a bellows-like contour with a jacket 15 and a suction chamber 17 configured as a cavity inside the jacket 15. Moreover, the suction gripper 10 has a connection side with an opening 16 in the jacket 15 via which a negative pressure can be applied to the suction chamber 17, for example, via the connection to a vacuum pump. Opposite from the connection-side opening 16, the suction gripper 10 has a suction side with an opening 18 in the jacket 15. When the suction gripper 10 is placed with its suction-side opening 18 onto an essentially flat object, such as a metal blank 50, in such a way that the cross section of the suction-side opening 18 of the jacket 15 is essentially completely closed, and when a negative pressure is applied to the suction chamber 17 via the connection-side opening 16, then the metal blank 50 is gripped by means of suction against the suction-side opening 18 of the suction gripper 10 and, depending on the relationship of the suction force on the one hand and the weight of the metal blank 50 on the other hand, the metal blank 50 can be picked up and held. In this context, the suction force per suction gripper 10 depends on the negative pressure and on the cross section of the suction-side opening 18.

Due to the bellows-like shape, the jacket 15 is elastically deformable in the vertical direction essentially perpendicular to the surface of the metal blank 50 that is to be picked up. Due to the jacket 15 that is elastically deformable in the vertical direction, the cross sectional surface 18 of the jacket 15 facing the metal blank 50 that is to be picked up can be adapted to the surface of the metal blank 50 to such an extent that, when a negative pressure is applied to the suction chamber 17 surrounded by the jacket 15, any leakage that might occur between the jacket 15 and the metal blank 50 remains so negligible that the negative pressure that can be generated by a vacuum pump is sufficient to grip the metal blank 50 by means of suction and to pick it up. Depending on the size and weight of the metal blank 50, several suction devices 10 can be combined with each other.

The jacket 15 is made of the steel grade X5CRNi18-10 (material number 1.4301). However, other austenitic steel grades with a low thermal conductivity such as, for example, X6CrNiTi18-10 (material number 1.4541), X15CrNiSi20-12 (material number 1.4828) or GX40CrNiSi25-20 (material number 1.4848) are suitable. Aside from steel grades, other materials are also suitable as long as they have an adequate heat resistance in conjunction with a sufficiently low thermal conductivity. By suitably selecting the material for the jacket 15, metal blanks 50 of various temperatures up to approximately 1000° C. can be picked up and held.

Due to the low thermal conductivity of the material of the jacket 15 of approximately 15 M/mK (X5CRNi18-10, X15CrNiSi20-12, GX40CrNiSi25-20) or approximately 16 W/mK (X6CrNiTi18-10), the heat dissipation from the metal blank 50 object that is to be lifted caused by contact with the suction grippers remains within acceptable limits; in particular, this does not cause the temperature of the blank to fall below a minimum temperature needed for the hardening process.

The jacket 15 has a thin-walled design in its entirety. As a result, the heat dissipation from the picked-up hot metal blank 50 is further reduced. In the embodiment shown, the wall thickness is approximately 0.5 mm. Greater but also smaller wall thicknesses can likewise be suitable, depending on the application case and on the material of the jacket. Here, smaller wall thicknesses further minimize the heat dissipation from the lifted hot metal blank 50 via the jacket 15. Moreover, jackets 15 with smaller wall thicknesses are more easily deformable. However, this is a drawback when the metal blanks 50 that are to be picked up are heavier. Moreover, extremely thin-walled suction grippers 10 are more susceptible to wear and tear. Therefore, the selection of the ideal wall thickness has to be made individually, depending on the application case. In order for the heat radiated by the blank not to be lost and for the suction gripper 10 not to become unnecessarily heated up, the inside of its jacket 15 is configured to reflect heat radiation, for example, in that an appropriately high-shine metal layer is applied onto it.

FIG. 2 is the top view of the underside of a baseplate 20 of a component-neutral vacuum lifting system according to the invention. Fifteen suction grippers 10 in a grid consisting of three times five suction grippers 10 are arranged on the underside of a baseplate 20. It is also possible to select vacuum lifting systems with a different number of suction grippers and different grid layouts. Suction gripper arrangements that do not follow a strict grid pattern are also conceivable. Owing to the parallel use of several suction grippers 10 that grip the same metal blank 50 by means of suction at different places, the load is distributed essentially uniformly among the suction grippers 10. As a result, the capacity of the individual suction grippers 10 can be less. Such an arrangement can also prevent or at least reduce sagging and warping of a picked-up hot metal blank 50. If the hot metal blank 50 has very thin walls, its mechanical strength can be relatively low at the prevailing temperatures of approximately 1000° C., so that there is a risk that the metal blank will sag or bulge at the place where it is being gripped by means of suction. These risks are markedly reduced by using several suction grippers 10 in parallel.

FIG. 3 is the top view of the underside of a baseplate 20 of a component-neutral vacuum lifting system with a metal blank 50 that has been picked up. The metal blank has a smaller surface area than the surface area that is covered by the suction grippers 10. As a result, the suction grippers 11 are not covered at all by the metal blank 50 and the suction grippers 12 are only partially covered. When a negative pressure is applied to all of the suction grippers 10, 11, 12, the suction grippers 11 and 12 would draw in atmospheric air unhindered, so that no significant negative pressure would be built up even in the suction chambers 17 of the suction grippers 10 that are completely covered by the metal blank 50 since the suction chambers 17 of the suction grippers 10, 11, 12 are supplied by the same central suction line. It would not be possible to lift the metal blank 50. Consequently, the suction grippers 10 of the vacuum lifting system are each connected via a valve to a central suction line, whereby each valve can be individually placed in an open or closed position. This can be done, for example, by means of solenoid valves. With this arrangement, the vacuum lifting system can be operated with just one vacuum pump. It can be installed in a decentralized place and can also supply other vacuum lifting systems with negative pressure. All that needs to be done is to connect a central vacuum line to the mobile vacuum lifting system, which optimizes the installation work and the mobility of the system. Moreover, the weight of the mobile part of the vacuum lifting system is reduced.

Consequently, the component-neutral vacuum lifting system makes it possible to lift different objects without having to retool the system for this purpose. It is sufficient to activate or deactivate individual suction grippers on an as-needed basis by opening or closing the appropriate valve.

The embodiments shown here merely constitute examples of the present invention and therefore should not be construed in a restrictive manner. Alternative embodiments taken into consideration by the person skilled in the art are likewise encompassed by the protective scope of the present invention.

### LIST OF REFERENCE NUMERALS

10 suction gripper

11 deactivated suction gripper

12 suction gripper partially covered by the metal blank

15 jacket

16 connection-side opening

17 suction chamber

18 suction-side opening

20 baseplate

50 metal blank

1-10. (canceled)

11. A suction device comprising a suction gripper for picking up and holding an essentially flat metal object, having a suction chamber and having a jacket that laterally encloses the suction chamber and that is elastically deformable in the vertical direction essentially perpendicular to the surface of the object that is to be picked up, characterized in that the jacket that is elastically deformable in the vertical direction consists of a metal that is heat-resistant up to at least 1000° C., with a low thermal conductivity, especially with a thermal conductivity of less than 20 W/mK.

12. The suction device according to claim 11, characterized in that the jacket that is elastically deformable in the vertical direction consists of a metal with a low thermal conductivity, especially with a thermal conductivity of approximately 15 W/mK.

13. The suction device according to claim 11, characterized in that the jacket has a thin-walled design, at least in the area that comes into contact with the metal object when it is being picked up.

14. The suction device according to claim 11, characterized in that the jacket has a thin-walled design in its entirety.

15. The suction device according to claim 11, characterized in that the jacket that is elastically deformable in the vertical direction has a bellows-like contour.

16. The suction device according to claim 11, characterized in that the jacket that is elastically deformable in the vertical direction has a disc-shaped contour.

17. A component-neutral vacuum lifting system, characterized in that the vacuum lifting system has a suction device according to claim 11.

18. The component-neutral vacuum lifting system according to claim 16, characterized in that the vacuum lifting system has a plurality of suction devices according to claim 11, whereby the vacuum lifting system has a baseplate with an underside, and the suction grippers are arranged in a grid on the underside of the baseplate.

19. The component-neutral vacuum lifting system according to claim 17, characterized in that the individual suction grippers can be activated and deactivated.

20. The component-neutral vacuum lifting system according to claim 18, characterized in that the suction grippers are each connected to a central suction line via a valve, whereby each valve can be individually placed in an open or closed position.
